(19) United States
(12) Patent Application Publication
(10) Pub. No.: US 2015/0280432 A1
(43) Pub. Date: Oct. 1, 2015

(54) HOME CHARGING AND POWER BACKUP UNIT

(71) Applicant: Detroit Electric Holdings, Limited, Detroit, MI (US)

(72) Inventor: Albert Lam, Detroit, MI (US)

(73) Assignee: DETROIT ELECTRIC HOLDINGS, LIMITED, Detroit, MI (US)

(21) Appl. No.: 14/674,342

(22) Filed: Mar. 31, 2015

Related U.S. Application Data
(60) Provisional application No. 61/973,751, filed on Apr. 1, 2014.

(51) Int. Cl. H02J 3/00

(52) U.S. Cl. CPC H02J 3/00

(57) ABSTRACT

A power switching unit for use with a power grid, a home power network, and a vehicle power network. A first power port is connectable to the power grid to receive power therefrom, a second power port is connectable to the vehicle power network, and a third power port is connectable with the home power network. A switch is in electrical communication with the first, second and third power ports, with the switch being transitional between first and second positions. In the first position, the switch places the first power port in electrical communication with the second and third power ports to enable the power grid to provide power to the vehicle power network and the home power network. In the second position, the switch places the second power port in electrical communication with the third power port, allowing the vehicle to provide power to the house power port.

### CROSS-REFERENCE TO RELATED APPLICATIONS

The present application claims the benefit of U.S. Provisional Application Ser. No. 61/973,751, filed Apr. 1, 2014, the contents of which are expressly incorporated herein by reference.

### STATEMENT RE: FEDERALLY SPONSORED RESEARCH/DEVELOPMENT

Not Applicable

### BACKGROUND

1. Technical Field

The present disclosure relates generally to a power supply management device for a home, and more specifically, to a device capable of monitoring the supply of power from a power grid, drawing power from an electric vehicle and supplying the power to the home in the event of power loss from the grid.

2. Description of the Related Art

Electric vehicles have grown in popularity in recent years due to their desirable fuel economy and their reduced emissions relative to conventional internal combustion vehicles. Electric vehicles are typically powered by one or more electric motors, which use energy stored in on-board batteries for driving the motor. After driving an electric vehicle for a period of time, the energy stored in the batteries becomes depleted, and therefore, electric vehicles are designed to be recharged to replenish the stored energy in the batteries.

Recharging of the batteries in an electrical vehicle typically occurs by connecting a power cable having a specially designed socket to a corresponding outlet formed on the vehicle. Typically, the owner of an electrical vehicle will have a charging cable at their home to allow the vehicle to recharge when the vehicle is parked at the home. In addition to charging at one's home, there has been a rapidly expanding network of public charging stations, which has made it easier to charge electric vehicles away from the home. For instance, government agencies, automakers, charging equipment manufacturers, etc., have contributed to the growing number of public charging stations.

It is understood that in some instances, the power grid supplying power to the home may experience a power loss. For instance, a severe weather event may cause a power loss, or the power loss may also be caused by an overload on the power grid, as commonly occurs in the hot summer months. In most instances, the power grid is the sole supply of power to the home and the vehicle recharging in the home, and thus, when power is no longer supplied from the grid, the home experiences a power outage and the vehicle stops recharging. A power loss from the power grid is typically a very undesirable occurrence since most households are dependent on the power grid to provide electricity for such basic needs as light, warm water, and refrigerated food. In the winter and summer months, the home may also use electricity from the grid to power a heater or air conditioner to maintain a safe and comfortable temperature within the home.

The batteries in an electric vehicle located at a home experiencing a power loss may have a sufficient amount of stored power to provide electricity to the home. For instance, the power loss may occur after the batteries in the vehicle have completely recharged. Furthermore, in view of the prevalence of publically available charging stations, the battery power of the electric vehicles may not be as depleted when the vehicles return to the home, and as such, even if the power loss occurs shortly after the vehicle returns to the home, the vehicle batteries may still have a good amount of stored power. Accordingly, an electric vehicle located at a home experiencing a power loss may be a good source of supplemental electrical energy. However, the conventional connection between the electrical network in the home and the vehicle is that power flows one way, namely, from the home to the vehicle, not from the vehicle to the home.

Accordingly, there is a need in the art for a power management device which monitors the supply of power from a power grid to a home, and draws power from a vehicle for supply to the home in the event of a power loss from the grid. Various aspects of the present disclosure address this particular need, as will be discussed in more detail below.

### BRIEF SUMMARY

In accordance with the present disclosure, there is provided a device and corresponding method for managing the communication of power to a home from an external power source. In a first, normal, operational mode, power is delivered from a power grid to a rechargeable vehicle and the home. However, in the event of power loss from the power grid, stored power is drawn from the vehicle and is supplied to the home to mitigate the consequences of grid power loss.

According to one embodiment, there is provided a power switching unit adapted for use with a power grid, a home power network, and a vehicle having a vehicle power network. The power switching unit includes a first power port configured to be connectable to the power grid to receive power therefrom, a second power port configured to be connectable to the vehicle power network, and a third power port configured to be connectable with the home power network. A switch is in electrical communication with the first power port, the second power port, and the third power port, with the switch being transitional between a first position and a second position. In the first position, the switch places the first power port in electrical communication with the second power port and the third power port to enable the power grid to provide power to the vehicle power network and the home power network. In the second position, the switch places the second power port in electrical communication with the third power port, to allow the electric vehicle to provide power to the house power port.

The first power port may be configured to detect a power loss from the power grid. The switch may be configured to automatically switch from the first position to the second position in response to a detected power loss by the first power port. The switch may also be configured to automatically switch from the second position to the first position in response to detection of power from the power grid. The switch may be configured to isolate the first power port from the second power port and the third power port when the switch is in the second position.

The power switching unit may additionally include a user input circuit adapted to receive a switch signal from a user, with the switch being configured to switch modes in response to receipt of the switch signal. The user input circuit may include a wireless communication circuit capable of receiving the switch signal via wireless communication.

The first power port may be configured to receive 100-240V AC from the power grid. The second power port may be configured to transmit 100-240V AC to the vehicle power network when the switch is in the first mode, and receive 100-240V AC from the vehicle power network when the switch is in the second mode. The second power port may be an IEC 62196 connector.

The power switching unit may further include a control unit capable of generating a command signal to the vehicle power network to provide power to the second power port.

According to another embodiment, there is provided a method of managing the communication of electrical power between a power grid, a vehicle power network, and a home power network. The method includes receiving electrical power from the power grid at a first power port. The electrical power received from the power grid is delivered to a second power port adapted to communicate electrical power to the vehicle power network for charging the vehicle, and a third power port adapted to communicate electrical power to the home power network. The method further includes the step of detecting a loss of electrical power from the power grid at the first power port, and receiving electrical power from the vehicle power network at the second power port subsequent to the detected loss of electrical power from the power grid. The electrical power received at the second power port is delivered to the third power port for supplying electrical power to the home.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a system level overview of a power management system constructed in accordance with an embodiment of the present disclosure;

FIG. 2 is a schematic diagram of the power management system shown in FIG. 1; and

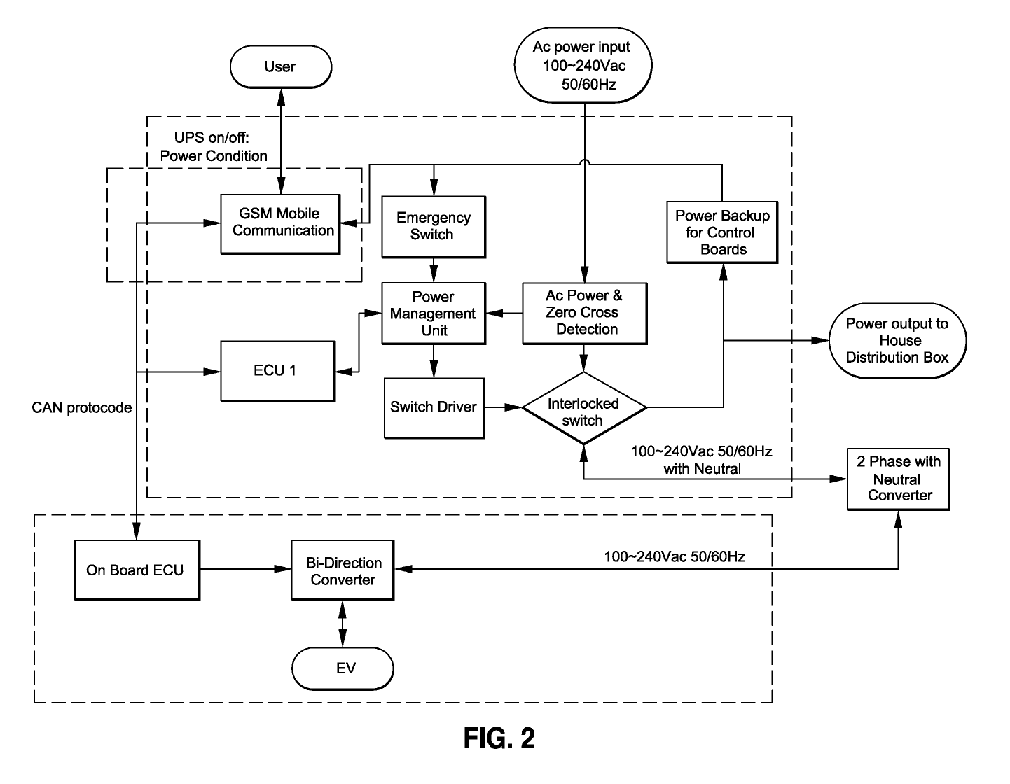

FIG. 3 is a schematic diagram of a power switching unit constructed in accordance with an embodiment of the present disclosure.

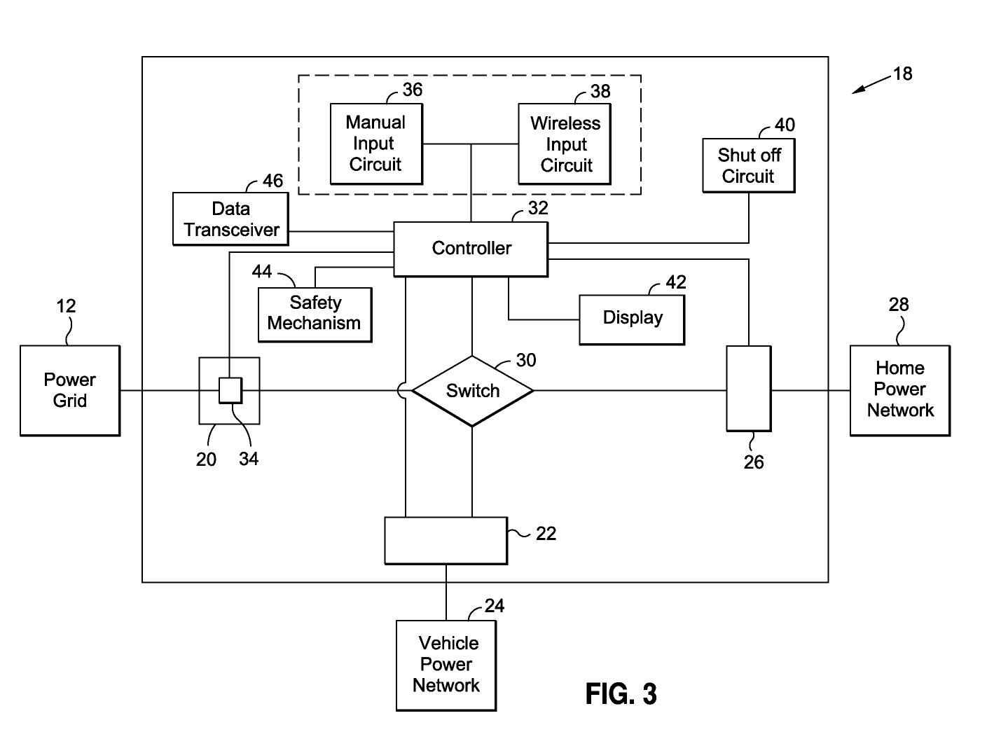

Common reference numerals are used throughout the drawings and the detailed description to indicate the same elements.

### DETAILED DESCRIPTION

The detailed description set forth below in connection with the appended drawings is intended as a description of certain embodiments of a power management system for use with an electric vehicle and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities. Additionally, as used herein, the term “power” is intended to mean electrical power, electrical energy or electricity.

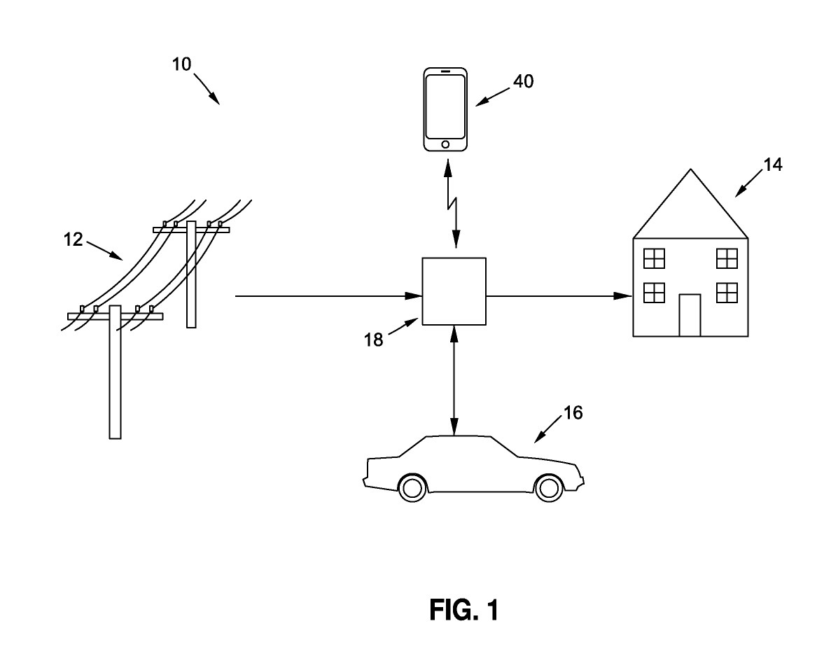

FIG. 1 depicts a power management system 10 for managing power between a power grid 12, a home 14, and an electric vehicle 16. As will be described in more detail below, the power is managed through a power switching unit 18 which is in electrical communication with the power grid 12, the home 14, and the electric vehicle 16. During normal conditions, i.e., when power is being received from the power grid 12, the power switching unit 18 delivers received power from the grid 12 to the electric vehicle 16 for recharging the vehicle 16, as well as delivering power to the home 14 for providing power to the electrical appliances therein. However, in the event of a power outage which results in power loss from the power grid 12, the power switching unit 18 draws stored power from the vehicle 16 and delivers that vehicle power to the home 14. Accordingly, the power switching unit 16 may allow an owner of an electric vehicle 16 to tap into the stored energy of the vehicle 16 in the event of a main power loss from the grid 12. Therefore, the electric vehicle 16 may serve as a backup power source to the home 14.

As used herein, the term “power grid” refers to an interconnected network for delivering electricity from one or more suppliers to one or more customers. The supplier may be a utility company which generates the electricity at a power station, e.g., nuclear, hydroelectric, wind farm, solar, etc.

As used herein, the term “electric vehicle” refers to any vehicle having stored electrical energy, including those vehicle capable of being charged from an external electrical power source. This may include vehicles having batteries which are exclusively charged from an external power source, as well as hybrid-vehicles which may include batteries capable of being at least partially recharged via an external power source.

The ability to switch the source of power to the home 14 is made possible by the power switching unit 18, which includes a power grid port 20 connectable to the power grid 12, a vehicle port 22 connectable to a vehicle power network 24 associated with the vehicle 16, and a home port 26 connectable to a home power network 28 associated with the home 14. The vehicle power network 24 includes the battery or batteries located on the vehicle 16, which provides power to the vehicle's electrical systems. The vehicle power network 24 may further include a plug or connector for connecting the vehicle power network 24 to an external power source for recharging the batteries. The home power network 28 generally includes the home's electrical network which is capable of distributing received electrical energy to the electrical outlets and appliances located in the home 14.

The power grid port 20 and the house port 26 may include terminals which are hard wired to the power grid 12 and home power network 28, respectively, to create a more permanent connection between the power switching unit 18 and the power grid 12 and home power network 28. Alternatively, the power grid port 20 and home port 26 may include plug-type connectors which allow for more rapid connection/disconnection of the power switching unit 18 to the power grid 12 and home power network 28. The ability to rapidly connect and disconnect the power switching unit 18 facilitates the deployment of the power switching unit 18 in times of emergency, e.g., widespread power loss. The vehicle port 22 may include a plug-type connector configured to detachably engage with the charging port/outlet on the vehicle 16. The vehicle port 22 may be required to comply with one or more standards associated with rechargeable vehicles. For instance, in one embodiment, the vehicle port 22 is an IEC 62196 compliant connector, although other connectors known in the art may also be used.

According to one embodiment, the power grid port 20 may be configured to receive 100-240V AC at a current in the range of 32-64 Amps from the power grid 12. Likewise, the vehicle port 22 may be configured to transmit and receive 100-240V AC at a current in the range of 32-64 Amps to and from the vehicle power network 24. Those skilled in the art will recognize that the foregoing values are exemplary in nature only, and that the parameters may change depending on the infrastructure of the power grid 12, the vehicle power network 24 and the home power network 28.

The power grid port 20, vehicle port 22, and home port 26 are each in electrical communication with a switch 30 capable of routing electrical power between the ports 20, 22, 26. The switch 30 is configured to be transitional between a first position and a second position. In the first position, the switch 30 places the grid port 20 in electrical communication with the vehicle port 22 and the home port 26 to enable the power grid 12 to provide power to the vehicle power network 24 and the home power network 28. In the second position, the switch 30 places the vehicle port 22 in electrical communication with the home port 26, to allow the electric vehicle 16 to provide power to the home port 26. During normal operational conditions, the power switching unit 18 will draw power from the power grid 12 to provide charging power to the electric vehicle 16 and to the home 14 by way of the vehicle port 22 and home port 26, respectively. In this respect, during normal operating conditions, the power from the grid 12 is supplied to both the home 14 and the vehicle 16. However, in the event of a power outage on the grid 12, the power switching unit 18 is capable of supplying stored electrical energy in the vehicle 16 to the home 14. In this respect, the power switching unit 18 allows the vehicle 16 to serve as the primary power feed to the home 14, at least for a limited period of time. Once power on the grid 12 is made available again, the switch 30 may transition from the second position back to the first position, to draw power from the grid 12 and supply power to the home 14 and the vehicle 16. According to one embodiment, the switch 30 may be configured to isolate the vehicle 16 and home 14 from the downed power grid 12 by isolating the grid power port 20 from the vehicle port 22 and the home port 26 when the switch 30 is in the second position. Once the switch 30 transitions back to the first position, the communication between the power grid 12, vehicle 16, and home 14 may be restored by placing the power grid port 20 in communication with the vehicle port 22 and the home port 26.

Operation of the switch 30 may be controlled by a controller 32, which is in communication with the switch 30, the ports 20, 22, 26, as well as various input devices and sensor(s), as will be explained below. According to one embodiment, the power switching unit 18 includes a power grid sensor 34 capable of detecting the power supplied from the power grid 12, as well as a loss of power from the grid 12. The power grid sensor 34 may be integrated into the power grid port 20 or may be formed separate from the power grid port 20. The power grid sensor 34 is in communication with the controller 32 to provide the controller 32 with status information regarding power received from the grid 12. In particular, when power is received from the power grid 12, the power grid sensor 34 detects the power and generates a POWER RECEIVED signal, which is then sent to the controller 32. If the sensor 34 detects a loss of power, the sensor 34 generates a NO POWER signal, which is then sent to the controller 32. When the controller 32 receives the POWER RECEIVED signal, the controller 32 generates a FIRST POSITION command signal, which is transmitted to the switch 30. The switch 30 is configured to assume the first position in response to receipt of the FIRST POSITION command signal. When the controller 32 receives the NO POWER signal from the power grid sensor 34, the controller 32 generates a SECOND POSITION command signal, which is transmitted to the switch 30. The switch 30 is configured to assume the second position in response to receipt of the SECOND POSITION command signal. According to one embodiment, the controller 32 automatically generates the FIRST POSITION command signal in response to receipt of the POWER RECEIVED signal, and the SECOND POSITION command signal in response to receipt of the NO POWER signal. In other words, the FIRST and SECOND POSITION command signals may be generated without any input by the user.

According to another embodiment, the power switching unit 18 may include a manual input circuit 36 in electrical communication with the controller 32 and adapted to allow a user to selectively transition the switch 30 between the first and second positions via manual input (e.g., pressing a button on the power switching unit 18). Along these lines, the manual input circuit 36 may generate and transmit FIRST POSITION and SECOND POSITION command signals to the controller 32 in response to respective inputs received from the user via the manual input circuit 36 for selectively positioning the switch 30. The manual input circuit 36 may be associated with a switch, dial, keypad, physical button or a virtual button on a touch screen display, etc., located on the power switching unit 18.

According to another embodiment, the power switching unit 18 may include a wireless input circuit 38 in electrical communication with the controller 32 and adapted to allow a user to provide input commands to the power switching unit 18 via wireless communication. The ability to wirelessly communicate control signal may be desirable for allowing the user to control operation of the power switching unit 18 via a mobile communication device 40 (e.g., a smartphone, tablet computer, etc.). In this regard, the wireless input circuit 38 may be capable of transmitting and receiving wireless signals in several different wireless protocols, including, but not limited to WiFi, Bluetooth™, GSM communications, or other wireless protocols known in the art. When the power switching unit 18 is used with a smartphone 40, the user may download a smart phone application (i.e., an “app.”) which provides the software on the smartphone 40 necessary for operating the power switching unit 18. Along these lines, when the app. is downloaded onto the smartphone 40, the user can selectively generate and transmit FIRST POSITION and SECOND POSITION command signals which are received by the wireless input circuit 38 and relayed to the controller 32 for selectively positioning the switch 30.

It is contemplated that when using the power switching unit 18 during a loss of power from the power grid 12, a user may not want to completely drain all of the power from the vehicle 16. In this respect, the user may want to leave enough power in the vehicle 16 to drive the vehicle 16 a preset minimum number of miles (e.g., 35 miles). Some vehicles 16 may come equipped with a built-in shutoff feature, which prevents the further drawing of power therefrom once the stored power levels in the vehicle 16 reach a prescribed minimum power level. However, if the vehicle 16 is not equipped with such a feature, the power switching unit 18 may include a shutoff circuit 40 which monitors the power level in the vehicle 16 and instructs the controller 32 to cease drawing power from the vehicle 16 when the power level in the vehicle 16 reaches the prescribed minimum power level.

The power switching unit 18 may include a built-in display 42 for providing information, preferably in a digital format, related to the energy usage from the grid 12 when the switch 30 is in the first position, and energy drawn from the vehicle 16 when the switch 30 is in the second position.

The power switching unit 18 may further include a built-in voltage regulator and power surge safety mechanism 44 for protecting the power switching unit 18, as well as the home 14 and vehicle 16 coupled to the unit 18.

According to one embodiment, the controller 32 may be configured to not only control the communication of power between the power switching unit 18 and the vehicle 16, but also the communication of data therebetween. In this respect, the power switching unit 18 may include a data transceiver 46 which is operatively connectable to a corresponding transceiver located on the vehicle 16. The controller 32 may have a database of stored communication protocols which enable communication with a number of different vehicles 16.

The power switching unit 18 may further include a retractable power cable with a line overheat temperature sensor with safety cut-off to prevent overheating of the cable. In this respect, the cable is required to be fully extended before charging or discharging can start. This safety feature is intended to mitigate overheating by a coiled cable.

Although the foregoing describes the use of the power switching unit 18 for drawing power from the vehicle 16 and supplying such power to a home 14 in the event of power loss from the grid 12, it is contemplated that the power switching unit 18 is also adapted to allow power to be drawn from the vehicle 16 even if power is not lost from the grid 12. In this respect, a user may choose to draw power from the vehicle 16 by inputting a command through one of the input circuits 36, 38 described above. When power is drawn from the vehicle 16, the switch 30 may isolate the grid 12, even though the grid 12 is capable of providing power. When the user wants to switch back to the grid 12, the user may once again use one of the input circuits 36, 38. It is also contemplated that the user may select a pre-programmed schedule for drawing power from the vehicle 16. For instance, the user may instruct the power switching unit 18 to draw power from the vehicle 16 for a prescribed period of time, and then switch back to drawing power from the grid 12. For instance, some utility companies place a premium on electricity during certain times of the day. Therefore, a user may instruct the power switching unit 18 to draw power from the vehicle 16 during those premium hours, based on the condition that the vehicle 16 is connected to the power switching unit 18, and then switch back to drawing power from the grid 12 when the rates have dropped.

Although the foregoing describes the power switching unit 18 for use in connection with a residential home, it is understood that the term “home” as used herein may refer broadly to any facility having a dedicated power network. In this respect, the power switching unit 18 may be used at a commercial facility for providing backup power via one or more electric vehicles 16. This may be particularly beneficial for a company which owns a fleet of electric vehicles 16, wherein the fleet of vehicles 16 may collectively supply power to the commercial facility in the event of a grid power loss.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A power switching unit adapted for use with a power grid, a home power network, and a vehicle having a vehicle power network, the power switching unit comprising:
a first power port configured to be connectable to the power grid to receive power therefrom;
a second power port configured to be connectable to the vehicle power network of the vehicle;
a third power port configured to be connectable with the home power network; and
a switch in electrical communication with the first power port, the second power port, and the third power port, the switch being transitional between a first position operative to place the first power port in electrical communication with the second power port and the third power port to enable the power grid to provide power to the vehicle power network and the home power network, and a second position operative to place the second power port in electrical communication with the third power port to allow the electric vehicle to provide power to the house power port.

2. The power switching unit recited in claim 1, wherein:
the first power port is configured to detect a power loss from the power grid;
the switch is configured to automatically switch from the first position to the second position in response to a detected power loss by the first power port.

3. The power switching unit recited in claim 2, wherein the switch is configured to automatically switch from the second position to the first position in response to detection of power from the power grid.

4. The power switching unit recited in claim 1, wherein the switch is configured to electrically isolate the first power port from the second power port and the third power port when the switch is in the second position.

5. The power switching unit recited in claim 1, wherein the second power port is an IEC 62196 connector.

6. The power switching unit recited in claim 1, further comprising a user input circuit adapted to receive a switch signal from a user, the switch being configured to switch positions in response to receipt of the switch signal.

7. The power switching unit recited in claim 6, wherein the user input circuit includes a wireless communication circuit capable of receiving the switch signal via wireless communication.

8. The power switching unit recited in claim 1, wherein the first power port is configured to receive 100-240V AC from the power grid.

9. The power switching unit recited in claim 1, wherein the second power port is configured to:
transmit 100-240V AC to the vehicle power network when the switch is in the first position; and
receive 100-240V AC from the vehicle power network when the switch is in the second position.

10. The power switching unit recited in claim 1, further comprising a control unit capable of generating a command signal to the vehicle power network to provide power to the second power port.

11. A method of managing communication of electrical power between a power grid, a vehicle power network, and a home power network, the method comprising the steps of:
(a) receiving electrical power from the power grid at a first power port;
(b) delivering electrical power received from the power grid to:
a second power port adapted to communicate electrical power to the vehicle power network for charging the vehicle; and
a third power port adapted to communicate electrical power to the home power network;
(c) detecting a loss of electrical power from the power grid at the first power port;
(d) receiving electrical power from the vehicle power network at the second power port subsequent to the detected loss of electrical power from the power grid; and
(e) delivering the electrical power received at the second power port to the third power port.

12. The method recited in claim 11, wherein step (d) proceeds automatically in response to the detected loss of power in step (c).

13. The method recited in claim 11, further comprising the steps of:
(f) detecting electrical power from the power grid at the first power port subsequent to a loss of power from the power grid at the first power port; and
(g) ceasing the receipt of electrical power from the vehicle power network in response to the detected electrical power from the power grid in step (e).

14. The method recited in claim 11, wherein step (d) comprises electrically isolating the first power port from the second power port and the third power port when electrical power is received from the vehicle power network.

15. The method recited in claim 11, wherein step (b) comprises delivering electrical power to a second power port which is an IEC 62196 connector.

16. The method recited in claim 11, wherein steps (d) and (e) are alternatively triggered by the receipt of a switch signal at a user input circuit in operative electrical communication with the first, second and third power ports.

17. The method recited in claim 16, wherein steps (d) and (e) are alternatively triggered by the receipt of a wireless signal at a user input circuit in operative electrical communication with the first, second and third power ports.

18. The method recited in claim 11, wherein step (a) comprises receiving 100-240V AC from the power grid.

19. The method recited in claim 11, wherein:
step (b) comprises transmitting 100-240V AC to the vehicle power network; and
step (d) comprises receiving 100-240V AC from the vehicle power network.

20. The method recited in claim 11, wherein step (d) comprises generating a command signal for transmission to the vehicle power network to provide power to the second power port in response to the detected loss of electrical power from the power grid in step (c).
